(19) United States
(12) Patent Application Publication
(10) Pub. No.: US 2006/0282850 A1
(43) Pub. Date: Dec. 14, 2006

(54) DIGITAL BROADCAST RECEIVER AND METHOD FOR CONTROLLING DISPLAY PROPERTIES OF DIGITAL BROADCAST

(76) Inventor: In Chel Kim, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(21) Appl. No.: 11/423,356

(22) Filed: Jun. 9, 2006

(30) Foreign Application Priority Data
Jun. 9, 2005 (KR) 10-2005-0049235

(51) Int. Cl. H04N 5/445

(52) U.S. Cl. 725/38

(57) ABSTRACT

A method for controlling at least one display property of digital broadcast signal using a digital broadcast receiver is disclosed. The method comprises determining a display mode for the received digital broadcast signal, and modifying at least one value of the at least one display property of the video data according to the determined display mode by looking up a specific table, wherein the specific table includes each value of the at least one display property that corresponds to each display mode.

This application claims the benefit of Korean Patent Application No. 10-2005-0049235, filed on Jun. 9, 2005, which is hereby incorporated by reference as if fully set forth herein.

### BACKGROUND OF THE INVENTION

1. Field of the Invention

The present invention relates to an apparatus and method for controlling digital properties of digital broadcast data, and more particularly to a digital broadcast receiver for changing/modifying display properties of received digital broadcast signal into a user preferred display properties without decrease in a transfer rate (i.e., a transmission speed) of the digital broadcast data.

2. Discussion of the Related Art

With rapid development and combining of technologies related to communication and broadcast, a user can view desired digital broadcast data from anywhere and at any time. For example, the user can view digital broadcast data at a specified place at a specified time, while in motion, and/or at a desired place at a desired time.

To keep pace with changing technology and trend, a Satellite Digital Multimedia Broadcasting (S-SMB) service was launched in the Republic of Korea in May 2005 to a variety of digital broadcast services throughout the world.

Conventionally, many developers have conducted extensive research into digital broadcast technologies associated with fixed receivers. However, the developers throughout the world are continuing to research technologies for providing a variety of digital broadcast services not only in the fixed receivers but in the mobile receivers as well.

For example, a Digital Audio Broadcasting (DAB) service, a Digital Video Broadcasting-Terrestrial (DVB-T) service, and a Digital Video Broadcasting-Handheld (DVB-H) service have been widely used in Europe, a Media Forward Link Only (FLO) service manufactured by Qualcomm Corporation has been widely used in the US, and a Digital Multimedia Broadcasting (DMB) service has been widely used in the Republic of Korea. With the widespread use of the above-mentioned digital broadcast services, terminal users can receive radio, TV, and teletext broadcast services in high-quality from anywhere at any time.

In addition, users may receive not only conventional music and TV broadcasting services, but also other application services associated with digital broadcast technologies. The services include, for example, a Transport Protocol Expert Group (TPEG) service for providing users with traffic information in real time, a Global Positioning System (GPS) service for providing location information of a vehicle or a person by using a satellite, an MP3 service for transmitting Compact Disc (CD)-quality audio signals received in a mobile digital broadcast receiver or a digital broadcast receiver of a vehicle to an MP3 player, such that the user can freely listen to desired MP3 music data from anywhere at any time, a slideshow service for providing a still image (e.g., a Joint Photographic Experts Group image), an Relationship (R)-commerce service, and a Broadcasting Website (BWS) service.

As described above, the digital broadcast service can provide users with a variety of multimedia content broadcast services (e.g., contents related to education, drama, news, sports, game, music, and movie contents). Therefore, the user can select and receive desired multimedia content data from the aforementioned contents according to preference, and the user can develop desire to create a variety of new contents through editing the received multimedia content data.

Conventionally, the user adjusts light and shade, brightness, and color of a display image using a screen adjustment menu an a TV, such that a user-desired display image suitable for the user's preference is displayed on the screen. However, if the above-mentioned screen adjustment method is applied to the conventional digital broadcast receiver capable of receiving digital broadcast signal, the following problems can arise.

First, the above-mentioned screen adjustment process is performed by a software. As a result, a transfer rate of transmission data may be decreased, and a display image may suddenly disappear on the screen while being displayed on the screen. As such, the digital broadcast cannot naturally display broadcast content data.

Second, the user cannot freely select a desired display mode from a variety of display modes.

### SUMMARY OF THE INVENTION

Accordingly, the present invention is directed to a digital broadcast receiver and method for controlling an image quality of digital broadcast data that substantially obviate one or more problems due to limitations and disadvantages of the related art.

An object of the present invention is to provide a method for controlling at least one display property of digital broadcast signal using a digital broadcast receiver.

Another object of the present invention is to provide a digital broadcast receiver for controlling at least one display property of digital broadcast data.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for controlling at least one display property of digital broadcast signal using a digital broadcast receiver is disclosed. The method comprises determining a display mode for the received digital broadcast signal, and modifying at least one value of the at least one display property of the video data according to the determined display mode by looking up a specific table, wherein the specific table includes each value of the at least one display property that corresponds to each display mode.

In another aspect of the present invention, there is provided a digital broadcast receiver for controlling at least one display property of digital broadcast data. The digital broadcast receiver comprises a digital broadcast reception unit for receiving a digital broadcast signal, a memory unit for storing information associated with one or more display modes and a specific table for matching at least one value of the at least one display property with each display mode, and a controller for determining a display mode and modifying the at least one value of the at least one display property of video data contained in received digital broadcast signal according to the determined display mode by looking up the specific table.

In a further aspect of the present invention, there is provided a method for controlling an image quality of digital broadcast data using a digital broadcast receiver. The method comprises modifying at least one display property of video data based on at least one display mode and a specific table, wherein the specific table includes each value of the at least one display property that corresponds to each display mode.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a digital broadcast receiver according to a preferred embodiment of the present invention;

FIG. 2 is a graph illustrating modification examples of a Red value denoted by 8 bits according to the present invention;

FIG. 3 is a graph illustrating changed/modified display properties examples of a Red value denoted by 5 bits according to the present invention; and

FIG. 4 is a flow chart illustrating a method for controlling display properties of digital broadcast signal according to a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention can be applied to a variety of digital broadcast standards (e.g., mobile digital broadcast standards and fixed digital broadcast standards).

Representative examples of the mobile digital broadcast standards include, as described above, an European DAB service based on the Eureka-147, a DVB-H service of Europe, a Media FLO service manufactured by Qualcomm Corporation, and a DMB service of the Republic of Korea. The DMB service of the Republic of Korea can be classified into a Terrestrial Digital Multimedia Broadcasting (TDMB) service based on the Eureka-147, and a Satellite Digital Multimedia Broadcasting (SDMB) service based on satellite communication.

Representative examples of the fixed digital broadcast standards include, as described above, a Digital Video Broadcasting-Terrestrial service of Europe, an Advanced Television Systems Committee (ATSC)-BVSB (Vestigial Sideband) service of the U.S., and an Integrated Services Digital Broadcasting (ISDB-T) service of Japan.

The above-mentioned digital broadcast standards are well known to those skilled in the art associated with broadcast communication technologies. As such, the detailed descriptions of the digital broadcast standards will herein be omitted for the convenience of description.

A detailed description of terms disclosed in the present invention will hereinafter be described in detail.

First, a term “display property” indicates a component for constituting a display of video data contained in digital broadcast data. Representative examples of the above-mentioned display properties include hue (i.e., color), brightness, saturation, and a Red/Green/Blue (RGB) model (i.e., three primary colors of light).

Second, a term “display mode” indicates displaying video data at a specific image property. If a current display property is changed to a different display property, a current display mode is also changed to a different display mode. For example, if a current display mode is a monochrome mode (i.e., a black-and-white mode), by changing the display properties, the monochrome mode can be changed to a color mode.

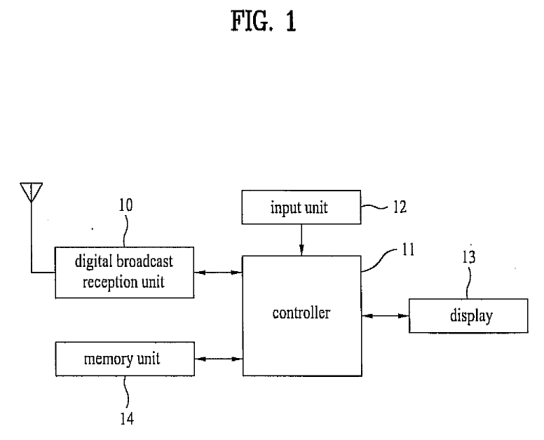

FIG. 1 is a block diagram illustrating a digital broadcast receiver according to a preferred embodiment of the present invention. A digital broadcast receiver capable of controlling at least one display property of digital broadcast data according to a preferred embodiment of the present invention will hereinafter be described with reference to FIG. 1.

Referring to FIG. 1, the digital broadcast receiver according to the present invention includes a digital broadcast receiving unit 10, a controller 11, an input unit 12, a display 13, and a memory unit 14.

The principal functions and operations of the above-mentioned display properties will hereinafter be described.

The digital broadcast receiving unit 10 receives digital broadcast signal(s) from a broadcast station. Here, the digital broadcast signal can include video data.

The controller 11 controls overall operations of the digital broadcast receiver, including the digital broadcast receiving unit 10, the input unit 12, the display 13, and the memory 14.

The input unit 12 receives a variety of information and data from a user, and the information/data can be inputted by various means including a keypad equipped with a variety of number/character keys and a touch-screen.

The display 13 displays a variety of information including a status of the digital broadcast receiver.

The memory unit 14 stores a predetermined program for controlling overall operations of the digital broadcast receiver. When overall operations of the above-mentioned digital broadcast receiver are executed by the controller 11, the memory unit stores Input/output (I/O) data and a variety of processed data.

A preferred embodiment of the digital broadcast receiver according to the present invention will hereinafter be described in reference to the operations of the controller 11.

The memory unit 14 stores a table which includes at least one display mode and display property values of each display mode that are mis-matched. That is, each display mode has a specified value associated with a plurality of display properties. For example, a display mode A has different display properties than those of a display mode B.

The above-mentioned display properties can be defined by a various characteristics. For example, the display properties, represented by hue, brightness, and saturation, can be matched or assigned to display modes. Alternatively, for example, the RGB model can be represented as the display properties to match or assign to the display modes. In addition, at least one value of the display property can be used to represent the display mode. For example, if the selected display mode indicates ‘joy,’ and the image is of a person smiling, by changing/adjusting the value to make the background brighter, the selected display mode can be satisfied.

As for the table, the table can be matched or assigned to display properties corresponding to specific resolution for each display mode. For example, a T-DMB service of the Republic of Korea displays video data at resolution of 320×240 pixels. In this case, according to a preferred embodiment of the present invention, if the user desires to change the current display properties of received digital broadcast data to a desired display properties using the RGB model, each display mode can have a set of RGB values corresponding to a resolution of 320×240 pixels. Further, the table can be edited (e.g., delete, modify).

In order to control/modify the display properties of digital broadcast data according to the present invention, specific digital broadcast signal must be available to the user. Since the image-quality control/modification operations is well known in the art and can be implemented in various ways, a detailed description will be omitted. However, as a representative example, if the digital broadcast signals are received in real time using a digital broadcast receiver, the digital broadcast data received in advance and stored in the memory unit 14 can be reproduced.

As discussed above, the controller 11 determines a display mode. To this end, the controller 11 can determine the display mode in various ways.

The input unit 12 first receives information of a display mode from the user. The controller then can determine the user selected display mode received via the input unit 12 as a display mode to be changed.

Thereafter, the controller 11 can determine a display mode according to additional information contained in the digital broadcast signal received via the digital broadcast receiving unit 10. For example, the controller 11 may determine a display mode using either Electronic Program Guide (EPG) information received from a broadcast station or header information of a specific broadcast program. A digital broadcast service based on the Eureka-147 receives header information via a Fast Information Channel (FIC). The additional information includes information associated with broadcast content data, and as such, the controller 11 can determine the display mode from to the broadcast content signal. For example, in the case of a sportscast, the controller 11 can determine a display mode to be a bright display mode. Alternatively, in the case of a horror movie, the controller 11 can determine a display mode to be a gloomy display mode. Alternatively, in the case of a western movie (also called an oater), the controller 11 can determine a display mode to be a monochrome mode.

Furthermore, the controller 11 determines a display mode according to a specific time (e.g., a reception time of digital broadcast, and a display properties modification time of received digital broadcast). The time for determining the display mode includes all the time-based categories (e.g., seasons, months, days, mornings, noon, and evenings). For example, different display modes may be assigned to the same digital broadcast signal capable of being provided to the user at different times. In more detail, for example, a display mode when the digital broadcast signal is provided to the user in the morning is different from a display mode when the digital broadcast signal is provided to the user in the evening.

Thereafter, if the controller 11 receives an input indicating the user's mood selection, the display mode can be determined accordingly to accommodate the user's mood selection. That is, the controller 11 has a table which has different moods classified categorically (e.g., sad, happy, tired). When the user makes a mood selection from the table, the controller 11 can determine an optimum display mode having different image-qualities corresponding to the mood selection.

The method for commanding the controller 11 to determine the display mode can be determined by the user. The controller 11 can provide the user with a user interface, equipped with a menu capable of allowing the user to select a desired display mode, via the display mode 13.

If the display mode is determined, the controller 11 uses the table stored in the memory unit 14 to look up display properties of video data contained in the digital broadcast signal and change the display mode to a different display mode having different display properties corresponding to the determined display mode. In other words, the controller 11 summons the display properties corresponding to the determined display mode from the table, and changes/adjusts the display mode accordingly.

The controller 11 can then display the digital broadcast signal (i.e., video data) having the modified display properties and/or adjusted display property values on the display 13 or instead can store the digital broadcast signal having modified display properties and/or adjusted display property values in the memory unit 14. Here, the user can set up the controller 11 to post-process (e.g., display or store) the modified digital broadcast signal.

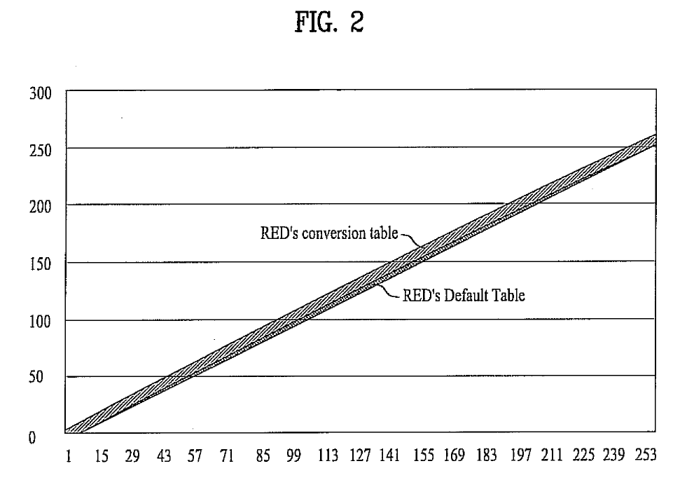

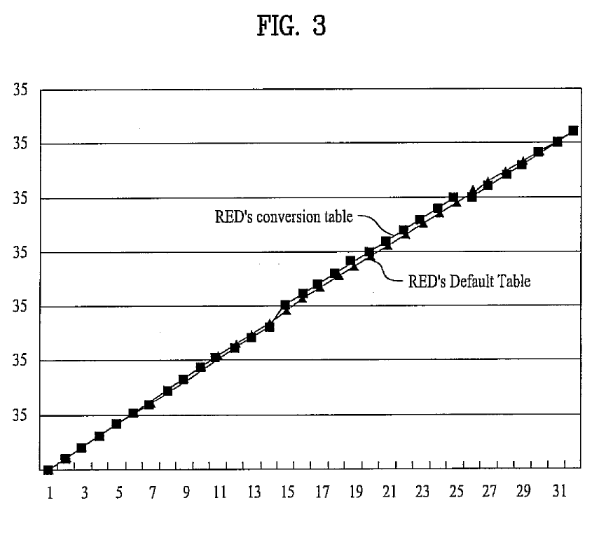

FIG. 2 is a graph illustrating modification examples of a Red value denoted by 8 bits according to the present invention. FIG. 3 is a graph illustrating changed/modified display properties examples of a Red value denoted by 5 bits according to the present invention. In FIGS. 2 and 3, illustrates an overall display represented by red hue by allowing many Red values to appear.

As another example, the RGB table corresponding to the monochrome mode eliminates most color and displays the image in black and white only. In the case of a night mode, a display image on the screen can be displayed in more vivid colors. Further, an overall display image may be displayed in blue (e.g., sea color), such that the user can experience fresh and cool modes. Alternatively, an overall display image can be displayed in green, such that the user may feel as if the user is in a mountain.

The above-mentioned function for controlling an display properties of digital broadcast data according to the present invention can be implemented in various ways, and their implementation examples will hereinafter be described in detail.

First, the control function associated with the display properties or at least one display property value can change/modify/adjust, in real time, the display properties of video data according to the user-selected display mode while receiving the video data of digital broadcast in real-time.

Second, the display properties or at least one display property value of a recorded video data of digital broadcast can be modified or adjusted according to the user-selected display mode, and thereafter displayed or stored.

Third, the user can view the digital broadcast signal having modified display properties or adjusted display property value, stored in the memory unit, at any time, anywhere. Here, the modified digital broadcast signal refers to the digital broadcast signal whose display properties or display property values has been modified/adjusted.

Fourth, the above-mentioned display property control function allows the user to select a desired display mode while viewing the modified/adjusted digital broadcast and subsequently view the digital broadcast of the selected display mode whose display properties and/or display property value has been modified/adjusted.

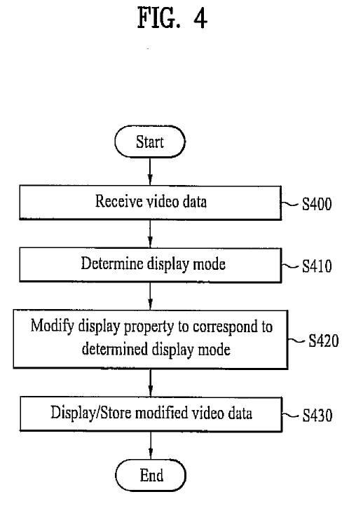

FIG. 4 is a flow chart illustrating a method for controlling display properties or at least one display property value of digital broadcast signal according to a preferred embodiment of the present invention. The method for controlling display properties/display property values of digital broadcast signal according to the present invention will hereinafter be described with reference to FIG. 4.

Referring to FIG. 4, digital broadcast signal is received from a broadcast station (S400). Thereafter, a display mode associated with the received digital broadcast signal is determined (S410). Detailed characteristics of the above-mentioned display mode are the same as stated above. Moreover, the method for determining the display mode is the same as stated above.

In more detail, the above-mentioned display mode may be determined according to the following three methods.

According to the first method, the display mode is determined based on additional information associated with broadcast content data contained in the received digital broadcast signal.

According to the second method, the display mode is determined based on a user-selected command.

According to the third method, the display mode is determined based on a specific time (e.g., a reception time of digital broadcast or display properties modification time of received digital broadcast).

After the display mode is determined, a table representing mis-matched at least one display mode and the display properties for each display mode is used or looked up to change the display properties or adjust the display property value of video data contained in the digital broadcast signal to match the display properties of the determined display mode (S420). Detailed descriptions of the display properties and/or its values and the table are the same as stated above.

In a subsequent step, a video data having the changed display properties and/or adjusted display property values is displayed or stored in a specified memory (S430).

In the embodiments of above, the video data is contained in the digital broadcast signal transmitted from the broadcast station. However, the source of the video data not limited to the digital broadcast signal, but the video data can be received from other sources as well, such as video data contained in a memory device, a DVD, a compact disc, and a like.

As described above, the digital broadcast receiver and method for controlling the display properties of digital broadcast according to the present invention have the following effects.

First, the present invention can modify display properties and/or adjust at lest one display property value of received digital broadcast signal into a user-desired display pattern on a hardware level, such that it can provide the user with the digital broadcast signal having the user-desired display properties or its values without affecting a transfer rate of the digital broadcast signal.

Second, the present invention provides the user with a variety of display modes having different mood selections to provide various user preferences and allow the user to select a desired display mode according to the user's preferences.

Third, the present invention allows the user to edit a table for modifying display properties and/or adjusting display property values of digital broadcast signal so as to allow the user to create a variety of new digital broadcast contents.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for controlling at least one display property of digital broadcast signal using a digital broadcast receiver, comprising the steps of:
a) determining a display mode for video data; and
b) modifying at least one value of the at least one display property of the video data according to the determined display mode by looking up a specific table, wherein the specific table includes each value of the at least one display property that corresponds to each display mode.

2. The method according to claim 1, wherein the at least one display property includes at least one of hue, brightness, and saturation.

3. The method according to claim 1, wherein the at least one display property is represented by a RGB (Red/Green/Blue) model.

4. The method according to claim 1, wherein the video data is contained in a digital broadcast signal transmitted from a broadcast station, the digital broadcast signal further includes additional information associated with broadcast content which is used to determine the display mode.

5. The method according to claim 1, wherein the display mode is determined by a user's selection command.

6. The method according to claim 1, wherein the display mode is determined by time.

7. The method according to claim 1, further comprising the step of:
c) displaying the video data which has been modified by the at least one display property.

8. The method according to claim 1, further comprising the step of:
d) storing the video data which has been modified by the at least one display property.

9. A digital broadcast receiver for controlling at least one display property of digital broadcast data, comprising:
a digital broadcast reception unit for receiving a digital broadcast signal;
a memory unit for storing information associated with one or more display modes and a specific table for matching at least one value of the at least one display property with each display mode; and
a controller for determining a display mode and modifying the at least one value of the at least one display property of video data contained in received digital broadcast signal according to the determined display mode by looking up the specific table.

10. The digital broadcast receiver according to claim 9, wherein the at least one display property includes at least one of hue, brightness, and saturation.

11. The digital broadcast receiver according to claim 10, wherein the at least one display property is represented by a RGB (Red/Green/Blue) model.

12. The digital broadcast receiver according to claim 9, wherein the received digital broadcast data includes additional information associated with broadcast content data, and the controller determines the display mode for modifying the at least one display property according to the additional information.

13. The digital broadcast receiver according to claim 9, further comprising:
an input unit for receiving information associated with the display mode, wherein the information is used to determine the display mode for modifying the at least one display property.

14. The digital broadcast receiver according to claim 9, wherein the controller determines the display mode for the at least one display property according to time.

15. The digital broadcast receiver according to claim 9, further comprising a display for displaying the video data having been modified by at least one display property.

16. The digital broadcast receiver according to claim 9, wherein the controller stores in the memory unit the video data which has been modified by the at least one display property.

17. A method for controlling an image quality of digital broadcast data using a digital broadcast receiver, the method comprising modifying at least one display property of video data based on at least one display mode and a specific table, wherein the specific table includes each value of the at least one display property that corresponds to each display mode.

18. The method of claim 17, wherein the video data is contained in a digital broadcast signal transmitted from a broadcast station.

19. The method of claim 17, further comprising:
displaying the video data which has been modified by the at least one display property; and
storing the video data which has been modified by the at least one display property.

20. The method of claim 17, wherein the at least one display property includes at least one of hue, brightness, saturation, and Red/Green/Blue colors.
